(19) United States
(12) Patent Application Publication
(10) Pub. No.: US 2025/0309280 A1
(43) Pub. Date: Oct. 2, 2025

(54) THIO-MODIFIED CARBON SUPPORTS AND METHODS THEREOF

(71) Applicant: Honda Motor Co., Ltd., Tokyo (JP)

(72) Inventors: Yiman ZHANG, San Jose, CA (US); Shutang CHEN, Livermore, CA (US); Gugang CHEN, Palo Alto, CA (US)

(21) Appl. No.: 18/624,270

(22) Filed: Apr. 2, 2024

(51) Int. Cl. H01M 4/92; H01M 4/86; H01M 4/88

(52) U.S. Cl. CPC H01M 4/926; H01M 4/8605; H01M 4/8825

(57) ABSTRACT

Aspects of the present disclosure generally relate to an electrocatalyst. The electrocatalyst including a thio-modified carbon support. The thio-modified carbon support including a carbon support, the carbon support including a carbon black. A ligand is coupled to the carbon support. The ligand including a thiol group. The thio-modified carbon support including a metal catalyst coupled to the ligand.

### FIELD

Aspects of the present disclosure generally relate to fuel cell catalysts and methods of use. Specifically, aspects of the present disclosure generally relate to thio-modified carbon supports and methods thereof.

### BACKGROUND

Various metal catalysts are utilized in fuel cells to enhance the conversion of raw materials to energy via direct electrochemical oxygen reduction reactions and hydrogen evolution reactions. These metal catalysts are typically in the form of a metal nanostructure with high-index facets. Platinum is the most commonly used and effective catalyst for fuel cells, e.g., proton exchange membrane fuel cells (PEMFCs). However, these platinum electrocatalysts suffer from poor durability as dissolution of the platinum electrocatalyst occurs at the cathode when operating at high potentials and under acidic conditions. Moreover, the high cost of conventional platinum electrocatalysts limits its widespread adoption in fuel cells.

Conventional approaches to overcome durability issues of platinum electrocatalysts have focused on stabilizing the platinum electrocatalysts using one or more supports, e.g., un-modified supports or modified supports, such as thiol modified. For example, carbon supports, e.g., carbon nanotubes and/or graphene, have recently been implemented to improve durability of platinum electrocatalysts. However, synthesizing these carbon supports involves harsh synthetic conditions and further increases the cost of platinum electrocatalysts, limiting the commercial viability of these stabilized platinum electrocatalysts.

There is a need for new fuel cell catalysts and methods thereof.

### SUMMARY

Aspects of the present disclosure can include electrocatalysts. The electrocatalysts including a thio-modified carbon support. The thio-modified carbon support including a carbon support, the carbon support including a carbon black. A ligand is coupled to the carbon support. The ligand including a thiol group. The thio-modified carbon support including a metal catalyst coupled to the ligand.

Aspects of the present disclosure can also include methods of producing an electrocatalyst. The methods including preparing a carbon slurry including a carbon support disposed in a diluent. The carbon support including a carbon black. A ligand precursor including at least a thiol group is introduced with the carbon slurry to form a thio-modified carbon support. A metal catalyst is coupled with the thio-modified carbon support to form the electrocatalyst.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only exemplary aspects and are therefore not to be considered limiting of its scope, for the disclosure may admit to other equally effective aspects.

FIG. 1 is a schematic of a thio-modified carbon support, according to at least one aspect of the present disclosure.

FIG. 2 is a flowchart of a method of forming a thio-modified carbon support, according to at least one aspect of the present disclosure.

FIGS. 3A-3C are images of a thio-modified carbon support, according to at least one aspect of the present disclosure. FIG. 3A is an image of a vulcanized carbon. FIG. 3B is an image of a first thio-modified carbon support. FIG. 3C is an image of a second thio-modified carbon support.

FIG. 4 is a graph illustrating exemplary data of an energy dispersive spectrum, according to at least one aspect of the present disclosure.

FIG. 5 is a graph illustrating exemplary data of a cyclic voltammetry spectrum, according to at least one aspect of the present disclosure.

FIG. 6 is a graph illustrating exemplary data of a Raman spectrum, according to at least one aspect of the present disclosure.

FIGS. 7A and 7B are graphs illustrating x-ray photoelectron spectra, according to at least one aspect of the present disclosure. FIG. 7A is a graph illustrating Cis overlapping spectra. FIG. 7A is a graph illustrating S₂ₚ overlapping spectra.

FIGS. 8A-8C are scanning electron microscope images of various carbon supports such as vulcanized carbon, a first thio-modified carbon support, and a second thio-modified carbon support, according to at least one aspect of the present disclosure. FIG. 8A is an image of vulcanized carbon. FIG. 8B is an image of a first thio-modified carbon support. FIG. 8C is an image of a second thio-modified carbon support.

FIGS. 9A-9C are transmission electron microscope images of various carbon supports such as vulcanized carbon, a first thio-modified carbon support, and a second thio-modified carbon support, according to at least one aspect of the present disclosure. FIG. 9A is an image of vulcanized carbon. FIG. 9B is an image of a first thio-modified carbon support. FIG. 9C is an image of a second thio-modified carbon support.

FIG. 10 is scanning electron microscope images representing element mapping of either a vulcanized carbon, a first thio-modified carbon support, or a second thio-modified carbon support, according to at least one aspect of the present disclosure.

FIGS. 11A-11F are graphs illustrating exemplary data of rotating disk electrode measurements, according to at least one aspect of the present disclosure. FIG. 11A is a cyclic voltammetry spectrum of a vulcanized carbon support. FIG. 11B is a cyclic voltammetry spectrum of a first thio-modified carbon support. FIG. 11C is a cyclic voltammetry spectrum of a first thio-modified carbon support. FIG. 11D is a linear sweep voltammetry spectrum of a vulcanized carbon support. FIG. 11E is a linear sweep voltammetry spectrum of a first thio-modified carbon support. FIG. 11F is a linear sweep voltammetry spectrum of a second thio-modified carbon support.

### DETAILED DESCRIPTION

Aspects of the present disclosure generally relate to thio-modified carbon supports and methods thereof. The present disclosure provides thio-modified carbon supports capable of having improved electrochemical oxygen reduction reaction performance when performing up to 30,000 cycles of an oxidation reduction reaction compared to conventional carbon supported platinum electrocatalysts, thereby improving fuel cell durability and a reduced dissolution at the cathode. The thio-modified carbon supports can be produced using a low temperature reaction, e.g., about 0° C. to about 25° C., thereby reducing the complex synthetic requirements of conventional carbon supports. Additionally, the thio-modified carbon supports can be produced from a lower cost carbon source, e.g., vulcanized carbon, thereby reducing the cost of production of stabilized platinum electrocatalysts when compared to conventional stabilized platinum electrocatalysts. Moreover, the carbon source can include a spheroid and/or nano-spheroid carbon source, increasing the surface area of the carbon source for the thiol modification as compared to a conventional carbon support, e.g., carbon nanotube and/or graphene, and thereby increasing the stabilization of the platinum electrocatalyst, such as by increasing binding affinity to the platinum metal catalyst. Additionally, the thio-modified carbon support can chelate to the platinum electrocatalyst, either along an edge of the platinum electrocatalyst and/or in a hollow cavity of the platinum electrocatalyst, thereby improving stabilization of the platinum electrocatalyst.

### Electrocatalyst

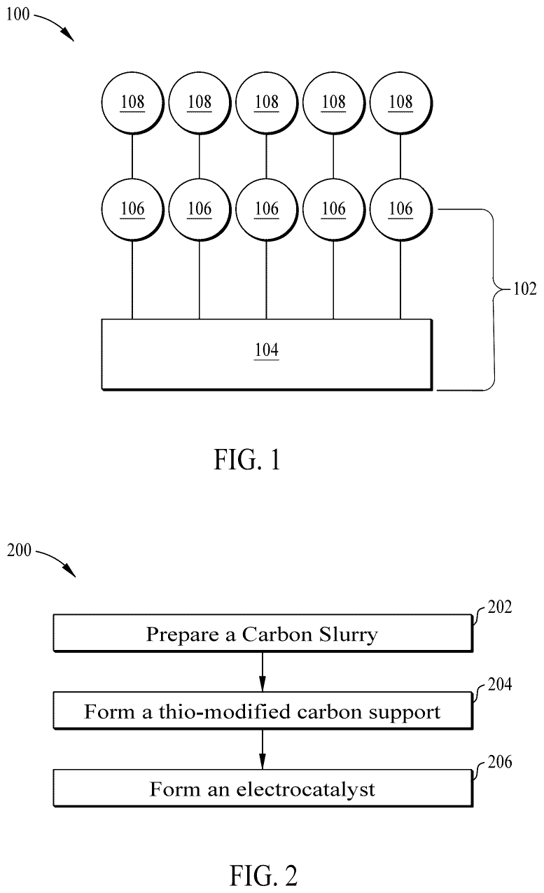

Now referring to FIG. 1, an electrocatalyst 100 is shown. The electrocatalyst 100 includes a thio-modified carbon support 102. The thio-modified carbon support 102 includes a carbon support 104. The carbon support 104 can include one or more sources of carbon such as carbon black, carbon nanotubes, graphene, or a combination thereof. For example, the thio-modified carbon support 102 can include a carbon black, e.g., a vulcanized carbon, thereby reducing the cost of production of the electrocatalyst 100 when compared to conventional electrocatalysts. In some aspects, the carbon support 104 has a density of about 80 kg/m³ to about 300 kg/m³, e.g., about 80 kg/m³ to about 280 kg/m³, about 160 kg/m³ to about 270 kg/m³, or about 250 kg/m³ to about 265 kg/m³. In some aspects, the carbon support 104 has a Mooney viscosity at 100° C. of about 55 to about 80, e.g., about 55 to about 78, about 58 to about 75, or about 66 to about 75. In some aspects, the carbon support 104 has a hardness shore A of about 60 to about 70, e.g., about 60 to about 68, about 64 to about 67, or about 65 to about 67. In some aspects, the carbon support 104 has a tensile strength of about 12 MPa to about 15 MPa, e.g., about 12 MPa to about 14 MPa, about 13 MPa to about 14 MPa, or about 13.3 MPa to about 14 MPa.

In some aspects, the carbon support 104 has a 100% modulus of about 1 MPa to about 4 MPa, e.g., about 1 MPa to about 3.8 MPa, about 2.0 MPa to about 3.1 MPa, or about 2.8 MPa to about 3.1 MPa. In some aspects, the carbon support 104 has a 200% modulus of about 4.0 MPa to about 8.0 MPa, e.g., about 4.5 MPa to about 7.0 MPa, about 5.2 MPa to about 6.5 MPa, or about 5.6 MPa to about 6.0 MPa. In some aspects, the carbon support 104 has a 300% modulus of about 6.0 MPa to about 10.0 MPa, e.g., about 7.0 MPa to about 9.5 MPa, about 7.5 MPa to about 9.2 MPa, or about 7.7 MPa to about 9.0 MPa. In some aspects, the carbon support 104 has an elongation at break % of about 400% to about 600%, e.g., about 400% to about 580%, about 430% to about 550%, or about 500% to about 520%.

In some aspects, the carbon support 104 can include a spheroid and/or nanospheroid shape. Without being bound by theory, a spheroid and/or nanospheroid shape can increase the surface area for the thiol modification as described in the present disclosure, when compared to a conventional carbon support, e.g., carbon nanotube and/or graphene, thereby increasing the stabilization of the platinum in the electrocatalyst. For example, the carbon support 104 can include a nanospheroid shape having a particle size of about 20 nm to about 60 nm, e.g. about 20 nm to about 50 nm, about 30 nm to about 50 nm, or about 40 nm to about 45 nm. In some aspects, the nanospheroid shape can include a surface area of about 40 m²/g to about 900 m²/g, e.g., about 40 m²/g to about 800 m²/g, about 50 m²/g to about 700 m²/g, about 80 m²/g to about 500 m²/g, about 120 m²/g to about 400 m²/g, about 200 m²/g to about 300 m²/g, or about 220 m²/g to about 280 m²/g. Without being bound by theory, a surface area of about 40 m²/g to about 900 m²/g can provide a larger surface area to bind thiol compared to conventional carbon supports, thereby increasing a binding capacity for the thio-modified carbon support to the platinum.

The thio-modified carbon support 102 includes a plurality of ligands 106 coupled to the carbon support 104. The ligands 106 independently include at least a thiol group, e.g., —SH. In some aspects, the ligands 106 can independently include a dithiol group, e.g., (—SH)₂. Without being bound by theory, the thiol group and/or dithiol group coupled to the carbon support 104 can enhance the chemical bonding between the carbon support and the metal catalyst 108, as described in the present disclosure, which can facilitate a more uniform film, thereby providing an enhanced physical loading method and hydrophobic loading method. Additionally, a reduction in catalyst dissolution, and concurrent increase in durability of the catalyst, can occur due to the thiol group and/or dithiol group chemically bonding to the metal catalyst. Moreover, the thiol and/or dithiol group can allow for the catalyst having a higher oxygen permeability compared to conventional catalysts, thereby improving the kinetics of the catalyst during an oxidation reduction reaction.

In some aspects, the plurality of ligands 106 independently include a modified C₁-C₁₀ alkyl, a modified C₁-C₁₀ alkylene, a modified C₆-C₂₀ aryl, and/or a modified C₃-C₂₀ alicyclic ring, in which each of the C₁-C₁₀ alkyl, C₁-C₁₀ alkylene, C₆-C₂₀ aryl, and/or C₃-C₂₀ alicyclic ring is modified with at least a thiol group, e.g., —SH. In some aspects, the ligand 106 can include a plurality of modified C₆-C₄₀ aryl rings joined together to form a cyclic and/or polycyclic ring structure, in which at least one of the plurality of modified C₆-C₄₀ aryl rings includes a thiol group, e.g., —SH. For example, the ligand 106 can include a C₆ phenyl ring, in which the C₆ phenyl includes at least a thiol group. As a further example, the ligand can be represented by the formula: —(C₆H₄S)—.

The electrocatalyst 100 includes at least a metal catalyst 108 disposed on (e.g., bonded to) the plurality of ligands 106. In some aspects, the metal catalyst 108 is a particle, such as a nanoparticle. In some embodiments, the metal catalyst 108 can include a metal substrate, e.g., a crystalline metal solid. In some aspects, the metal catalyst 108 includes a transition metal, a lanthanide metal, an actinide metal, or combinations thereof. For example, the metal catalyst 108 can include a Group VI transition metal such as chromium (Cr), molybdenum (Mo), and tungsten (W); a Group VIII transition metal such as iron (Fe), cobalt (Co), nickel (Ni), ruthenium (Ru), rhodium (Rh), palladium (Pd), osmium (Os), Iridium (Ir), and platinum (Pt). The metal catalyst 108 can include a transition metal, such as a d-block transition metal, an f-block transition metal, or combinations thereof. For example, the catalyst particles can include a d-block transition metal such as an iron, nickel, cobalt, gold, silver, platinum, or combinations thereof.

In some aspects, a combination of two or more metal catalysts 108 are used, for example, a mixture of two or more of platinum, iron, nickel, and cobalt, such as a 50:50 mixture (by weight) of platinum and cobalt. The metal catalyst 108 can include a pure metal, a metal oxide, a metal carbide, a nitrate salt of a metal, and/or other compounds containing one or more of the metals described herein.

In some aspects, the metal catalyst 108 includes a hollow particle, having an edge and a cavity. The metal catalyst 108 can align to the thiol of the thio-modified carbon support such that an edge of the metal catalyst 108 binds to the thiol. In some aspect's, the thiol of the thio-modified carbon support 102 can bind to a plurality of edges of the metal catalyst 109, thereby acting as a chelator to the metal catalyst 108, and improving stabilization of the electrocatalyst 100. In some aspect's, the metal catalyst 108 can align to the thiol of the thio-modified carbon support such that the thiol fits within a cavity of the metal catalyst 108 and the cavity binds to the thiol group. Without being bound by theory, a thiol group bound to a cavity of the metal catalyst can provide enhanced stability of the electrocatalyst as the thiol and the metal catalyst are both chemically and sterically bound.

In some aspects, the electrocatalyst 100 can include a weight ratio of thio-modified carbon support 102 to metal catalyst 108 of about 0.1:1 to about 10:1. For example, the electrocatalyst 100 can include a weight ratio of about 0.1:1 to about 1:1 of the thio-modified carbon support 102 to the metal catalyst 108, e.g., about 0.1:1 to about 0.9:1, about 0.2:1 to about 0.8:1, about 0.3:1 to about 0.7:1, or about 0.4:1 to about 0.6:1. As a further example, the electrocatalyst 100 can include a weight ratio of about 1:1 to about 10:1 of the thio-modified carbon support 102 to the metal catalyst 108, e.g., about 1:1 to about 9:1, about 2:1 to about 8:1, about 3:1 to about 7:1, or about 4:1 to about 6:1. Without being bound by theory, an electrocatalyst including a weight ratio of thio-modified carbon support 102 to the metal catalyst 108 or about 1:1 can provide increased durability of the electrocatalyst, and reduced dissolution at the cathode.

In some aspects, the electrocatalyst 100 can include a spheroid and/or nanospheroid shape. In some embodiments, the electrocatalyst 100 can include a nanospheroid shape having a particle size of about 20 nm to about 60 nm, e.g. about 20 nm to about 50 nm, about 30 nm to about 50 nm, or about 40 nm to about 45 nm. In some aspects, the nanospheroid shape can include a surface area of about 10 m²/g to about 300 m²/g, e.g., about 20 m²/g to about 290 m²/g, about 50 m²/g to about 250 m²/g, about 80 m²/g to about 200 m²/g, about 150 m²/g to about 180 m²/g, or about 160 m²/g to about 170 m²/g. Without being bound by theory, a surface area of about 10 m²/g to about 300 m²/g can provide a larger surface area to allow for increased concentrations of metal catalysts on the electrocatalyst, thereby increasing efficiency of the electrocatalyst while maintaining durability at higher temperatures.

In some embodiments, the electrocatalyst 100 of the present disclosure can provide a dual anode and cathode in a proton exchange membrane fuel cell. Additionally, the electrocatalyst 100 of the present disclosure can provide a dual anode and cathode in an alkaline exchange membrane fuel cell.

### Methods

Now referring to FIG. 2, a method 200 of producing an electrocatalyst 100 is shown. At operation 202, a carbon slurry is prepared. In some aspects, the carbon slurry can include one or more carbon supports 104 disposed in a solvent. The one or more carbon supports 104 can include the carbon supports 104 described in the present disclosure. The solvent can include an aqueous and/or organic solvent, e.g., methanol. For example, the solvent can include water. In some aspects, about 0.1 g to about 100 kg of the one or more carbon supports 104, e.g., about 0.1 g to about 10 kg, about 1 g to about 1 kg, about 100 g to about 500 g, or about 0.1 g to about 1 g, may be placed in about 10 mL to about 100 L of the solvent, e.g., about 10 mL to about 10 L, about 100 mL to about 1 L, about 100 mL to about 500 mL, or about 10 mL to about 100 mL.

In some aspects, the carbon slurry can be stirred and/or sonicated. For example, the carbon slurry can be sonicated at a frequency of about 20 kHz to about 80 kHz, e.g., about 20 kHz to about 70 kHz, about 30 kHz to about 60 kHz, or about 40 kHz to about 50 kHz, using a power of about 55 Watts to about 300 watts, e.g., about 60 Watts to about 250 Watts, about 80 Watts to about 200 Watts, or about 100 Watts to about 150 Watts. In some aspects, the carbon slurry can be sonicated for a period of about 10 min to about 60 min, e.g., about 10 min to about 50 min, about 20 min to about 40 min, or about 25 min to about 35 min. As a further example, the carbon slurry can be sonicated for a period of time suitable to prevent visible solids from being seen in the slurry.

At operation 204, a thio-modified carbon support 102 is formed. The thio-modified carbon support 102 can include any of the thio-modified carbon support 102 as described in the present disclosure. In some aspects, the thio-modified carbon support 102 is formed by reacting a ligand precursor with the carbon slurry. In some aspects, reacting the ligand precursor with the carbon slurry can include forming a mixture by adding the ligand precursor to the carbon slurry. The ligand precursor includes any of the ligand 106 described in the present disclosure. The ligand precursor can be converted to a ligand upon interaction with the carbon slurry and/or carbon support. In some aspects, the ligand precursor can include an amino precursor, in which an amino precursor includes the ligand 106 having a substitution at least one hydrogen for an amino group. For example, the ligand precursor can include an aminothiophenol. In some aspects, about 0.002 mg/mL to about 1 g/mL of the ligand precursor is added to the carbon slurry, e.g., about 0.002 mg/mL to about 900 mg/mL, about 0.1 mg/mL to about 800 mg/mL, about 10 mg/mL to about 700 mg/mL, about 400 mg/mL to about 600 mg/mL, or about 500 mg/mL to about 550 mg/mL.

In some aspects, the ligand precursor is added to the carbon slurry at a weight ratio of ligand precursor to carbon support of about 0.1:1 to about 10:1. For example, the weight ratio of ligand precursor to carbon support can be about 0.1:1 to about 1:1, e.g., about 0.1:1 to about 0.9:1, about 0.2:1 to about 0.8:1, about 0.3:1 to about 0.7:1, or about 0.4:1 to about 0.6:1. As a further example, the weight ratio of ligand precursor to carbon support can be about 1:1 to about 10:1, e.g., about 1:1 to about 9:1, about 2:1 to about 8:1, about 3:1 to about 7:1, or about 4:1 to about 6:1.

In some aspects, an alkali metal nitrate is added to the mixture of the ligand precursor and carbon slurry. In some aspects, the alkali metal nitrate includes nickel (II) acetylacetonate. In some aspects, about 0.002 mg/mL to about 50 mg/mL of the alkali metal nitrate is added to the mixture, e.g., about 0.002 mg/mL to about 40 mg/m, about 0.1 mg/mL to about 30 mg/mL, about 1 mg/mL to about 30 mg, or about 10 mg/mL to about 20 mg/mL. In some aspects, the alkali metal nitrate is added to the mixture at a weight ratio of alkali metal nitrate to ligand precursor of about 0.1:1 to about 10:1. For example, the weight ratio of alkali metal nitrate to ligand precursor can be about 0.1:1 to about 1:1, e.g., about 0.1:1 to about 0.9:1, about 0.2:1 to about 0.8:1, about 0.3:1 to about 0.7:1, or about 0.4:1 to about 0.6:1.

In some aspects, the mixture of the ligand precursor, alkali metal nitrate, and carbon slurry can be stirred for a period of about 1 min to about 20 min, e.g., about 1 min to about 18 min, about 2 min to about 15 min, or about 5 min to about 10 min. As a further example, the carbon slurry can be stirred for a period of time suitable to prevent visible solids from being seen in the mixture.

In some aspects, following the stirring period, the mixture of the ligand precursor, alkali metal nitrate, and carbon slurry is cooled to about −10° C. to about 10° C., e.g., about −10° C. to about 5° C., about −5° C. to about 5° C., or about −1° C. to about 1° C. In some aspects, after cooling, about 0.1 mL to about 100 mL of acid is added to the mixture, e.g., about 0.1 mL to about 90 mL, about 1 mL to about 80 mL, about 2 mL to about 50 mL, or about 3 mL to about 10 mL. In some aspects, the acid includes hydrochloric acid, sulfuric acid, formic acid, acetic acid, nitric acid, carbonic acid, phosphoric acid, citric acid, or a combination thereof. For example, the acid can include hydrochloric acid. Without being bound by theory, the acid can remove excess alkali metal, e.g., nickel, from the thio-modified carbon support 102. In some aspects, after addition of the acid the mixture can be stirred at a temperature of about −10° C. to about 10° C., e.g., about −10° C. to about 5° C., about −5° C. to about 5° C., or about −1° C. to about 1° C. The mixture can be stirred for a period of about 10 min to about 60 min, e.g., about 10 min to about 50 min, about 20 min to about 40 min, or about 25 min to about 35 min.

In some aspects, the thio-modified carbon support 102 can be obtained by filtering the mixture through a membrane and obtaining the filtered product. The membrane can include a pore size of about 0.1 μm to about 1 μm, e.g., about 0.1 μm to about 0.9 μm, about 0.2 μm to about 0.7 μm, about 0.3 μm to about 0.5 μm, or about 0.4 μm to about 0.5 μm. In some aspects, the filtered product, such as the filtrand, e.g., the thio-modified carbon support, can be washed and dried.

At step 206, an electrocatalyst 100 is formed. The electrocatalyst is formed by coupling a metal catalyst 108 to the thio-modified carbon support 102. The metal catalyst 108 can include any of the metal catalyst precursors. The metal catalyst 108 can be formed by a metal catalyst precursor, which can be converted to an active catalyst as metal catalyst 108 upon interaction with the thio-modified carbon support 102. The metal catalyst precursor can include one or more transition metal salts, lanthanide metal salts, actinide metal salts. Metal salts include metal nitrates such as a transition metal nitrate; acetates such as a transition metal acetate; cyanates such as a transition metal cyanate; acetylacetonates such as a transition metal acetylacetonate; citrates such as a transition metal citrate; fluorides such as a transition metal fluoride; chlorides such as a transition metal chloride; bromides such as a transition metal bromide; iodides such as a transition metal iodide; hydrates thereof; or combinations thereof. Other metal salts include those with different counter-anions are contemplated. In some examples, the metal catalyst precursor may be a metallocene, a metal acetylacetonate, a metal phthalocyanine, a metal porphyrin, a metal salt, a metalorganic compound, or combinations thereof. In some aspects, the metal catalyst precursor can include Pt60Ni40.

In some aspects, about 0.002 mg/mL to about 1 g/mL of the metal catalyst precursor is added to the thio-modified carbon support 102, e.g., about 1 mg/mL to about 900 mg/mL, about 2 mg/mL to about 500 mg/mL, about 3 mg/mL to about 100 mg/mL, about 4 mg/mL to about 50 mg/mL, or about 5 mg/mL to about 7 mg/mL. In some aspects, the metal catalyst precursor is mixed with the thio-modified carbon support 102 at a weight ratio of metal catalyst precursor to thio-modified carbon support 102 of about 0.1:1 to about 10:1. The metal catalyst precursor may be mixed at a temperature of about 0° C. to about 80° C., e.g., about 0° C. to about 70° C., about 20° C. to about 60° C., about 30° C. to about 50° C., or about 35° C. to about 45° C. The metal catalyst precursor can be mixed for about 30 minutes to about 24 hours, e.g., about 30 minutes to about 23 hours, about 1 hour to about 20 hours, about 3 hours to about 15 hours, or about 8 hours to about 12 hours, in solvent, e.g., water, isopropyl alcohol, or a combination thereof. For example, the weight ratio of metal catalyst precursor to thio-modified carbon support 102 can be about 0.1:1 to about 1:1, e.g., about 0.1:1 to about 0.9:1, about 0.2:1 to about 0.8:1, about 0.3:1 to about 0.7:1, or about 0.4:1 to about 0.6:1. As a further example, the weight ratio of metal catalyst precursor to thio-modified carbon support 102 can be about 1:1 to about 10:1, e.g., about 1:1 to about 9:1, about 2:1 to about 8:1, about 3:1 to about 7:1, or about 4:1 to about 6:1.

### EXAMPLES

### Characterization

Surface morphologies and elemental mapping were investigated by a scanning electron microscope (SEM, QUANTA FEG 650, from Phillips/FEI, at Amsterdam Netherlands with a field emitter as an electron source. Transmission electron microscopy (TEM) images were captured using a Tecnai 20 microscope from Phillips/FEI, at Amsterdam Netherlands with an accelerating voltage of 200 kV. The surface chemical information of the different carbon was characterized by X-ray photoelectron spectroscopy (PHI, VersaProbe 3 XPS, from Physical Electronics of Chanhassen, MN, USA). Raman spectroscopy utilized a Via™ Raman Microscope from Renishaw Dundee IL, USA to indicate the D/G ratio after thio-modification. All electrochemical characterization is conducted with VSP-3e potentiostat (BioLogic, Seyssinet-Pariset France).

### Electrochemical Measurements

All the electrochemical measurements were measured on an electrochemical workstation at room temperature, e.g., 25° C., using a three electrode electrochemical setup with a rotating disk electrode (RDE) system. A glassy carbon working electrode (GCE, 5 mm inner diameter, 0.196 cm²), a graphite rod counter electrode, and a 3.0 M KCl saturated Ag/AgCl reference electrode in 0.1 M HClO₄ electrolyte were used for all measurements of the present disclosure. The working electrode was prepared by dropping 10 μL of the electrocatalyst of the present disclosure on the GCE, which was dried in ambient condition. All potentials are with respect to a reversible hydrogen electrode (RHE). The potential at the zero current point was the reaction potential of the hydrogen electrode. The potential at the zero current point was determined to be −0.287 V, so the potential measured with a Ag/AgCl electrode can be related by E (RHE)=E (Ag/AgCl)+0.287 V

The cyclic voltammetry (CV) characterization of the catalyst electrode was in the potential range of 0.1-1.1 V (vs. RHE) at a scan rate of 50 mV s⁻¹ in a Ar-saturated 0.1 M HClO₄ electrolyte solution. The oxidation reduction reaction (ORR) polarization curves were recorded in an O₂-saturated 0.1 M HClO₄ electrolyte at a rotation speed of 1600 rpm and a scan rate of 20 mV s⁻¹ from 1.0 V to 0.2 V. For the cyclic voltammetry (CV) activation and ORR processes of Pt—Ni nano-catalysts, the ORR activity was conducted immediately after a thirty-cycle CV activation.

### Thio-Modified Carbon Support Synthesis

0.5 grams of vulcanized carbon, commercially available as Vulcan® XC-72, from The Fuel Cell Store of Boulder, Colorado, USA, was ground and stored in a test tube before transferring to a 100 ml beaker with a stir bar. De-ionized (DI) water, 50 mL, was added, and the resulting slurry was sonicated for 30 mins. 4-Aminothiophenol, 521 mg, was added followed by the addition of NaNO₂, 287 mg. The mixture was stirred until no visible solids were observed, e.g., about 5 to 10 mins. After cooling to 0° C. by an ice/water bath, concentrated HCl, 5 mL, was added dropwise. The mixture was stirred at 0° C. for 30 mins. The thio-modified carbon support was collected by filtering through a 0.47 μm nylon filtration membrane and then washed with DI water, 20 mL×2, dimethylformamide (DMF), 20 mL, methanol, 20 mL, and acetone, 20 mL, sequentially. Subsequently, the thio-modified carbon support was air-dried overnight and then further dried using a high vacuum system at 40° C. for 4 h. Two types of modified carbon were formed denoted as Example 1 and Example 2. Example 1 includes trace amounts of free thio group, while no free thio exists in Example 2.

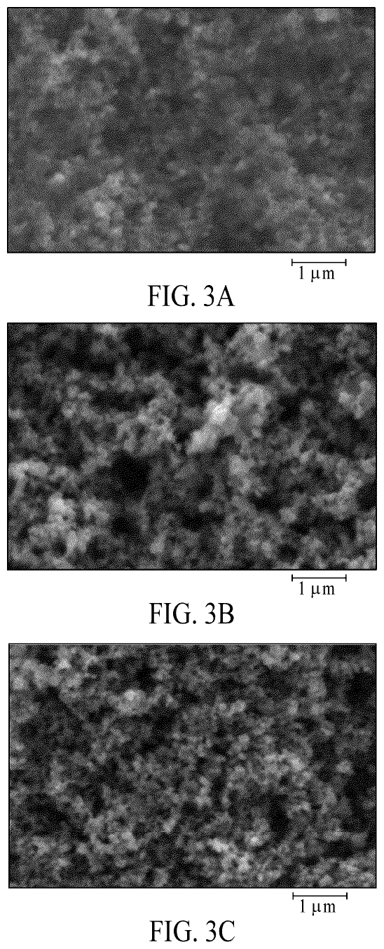

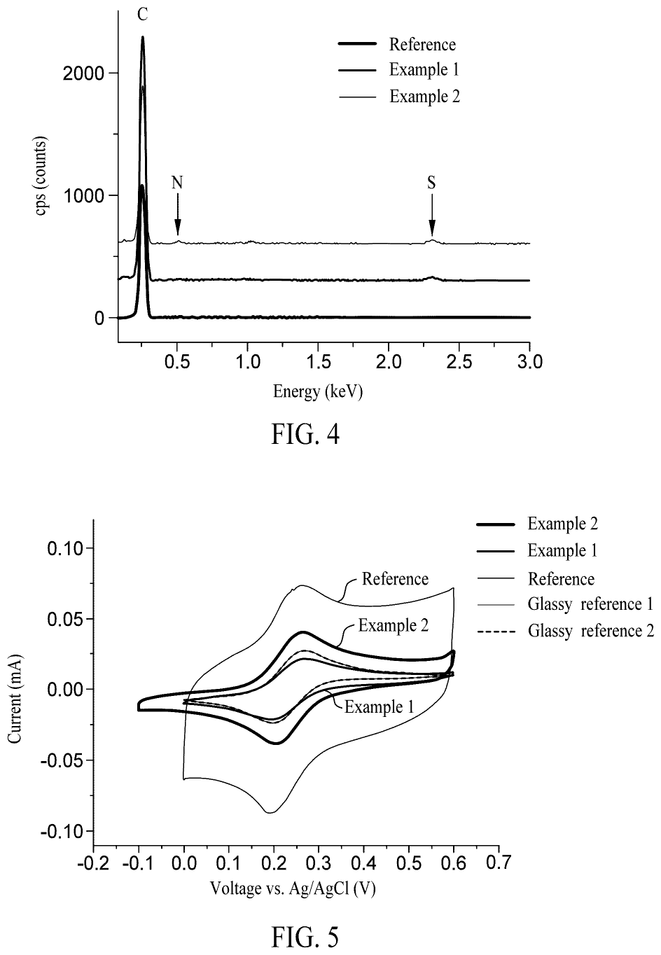

No morphology differences were shown between reference, example 1, and example 2, indicating formation of the thio-modified carbon support, as shown in FIGS. 3A-3C. A uniform distribution of carbon (C), sulfur(S), and nitrogen (N) was found in the energy dispersive spectrum of SEM elemental mapping of reference, example 1, and example 2, as shown in FIG. 4. A presence of N and S was found in example 1 and example 2, as shown below in Table 1.

TABLE 1

| Element | Reference | Example 1 | Example 2 |
|---|---|---|---|
| C (wt %) | 100 (0.0) | 88.0 +/− 1.0 | 93.1 +/− 0.9 |
| S (wt %) | 0 (0.4) | 10.2 +/− 0.8 | 6.2 +/− 0.8 |
| N (wt %) | 0 (0.4) | 1.7 +/− 0.6 | 0.7 +/− 0.5 |

A CV curve was obtained for a potassium ferrocyanide electrolyte solution, as shown in FIG. 5. The oxidation peak, at 0.25 V and the reduction peak at 0.20 V, corresponded to a reversible Fe³⁺/Fe²⁺ redox. The difference between peak centers of the positive voltage sweep and the negative voltage sweep indicated the purity of the carbon surface. The reference showed a difference of 62 mV which is close to that of glassy carbon electrode 1 (glassy reference 1) and glassy carbon electrode 2 (glassy reference 2) at 68-70 mV. Example 1 showed a higher difference, 93 mV, while example 2 showed a lower difference, 55 mV for C2, indicating that the surface had been modified.

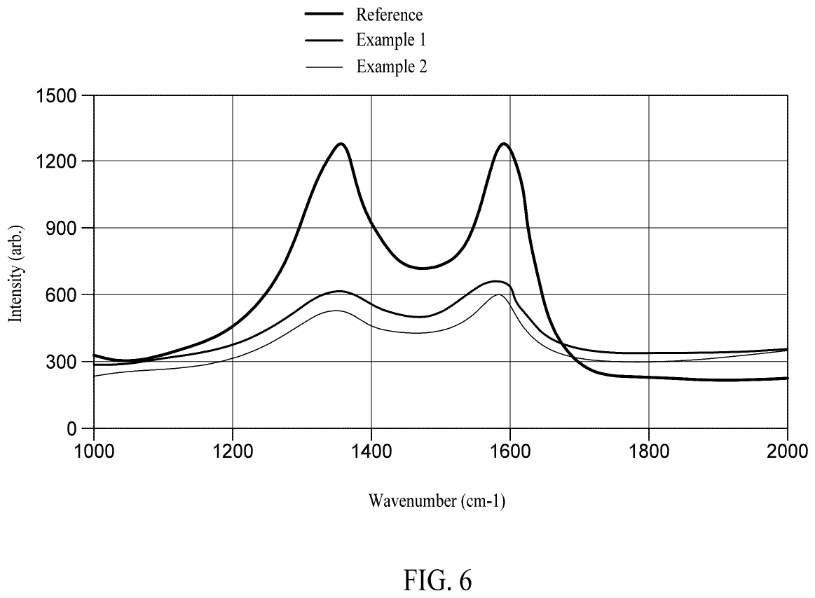

Raman spectroscopy showed a reduction in both the D and G bands of carbon, indicating that a layer was present on the surface of the carbon support, as shown in FIG. 6. The G band, arising from the stretching of the C—C bond, was centered around 1604 cm⁻¹. The D band centered around 1356 cm⁻¹. I_{G}/I_{D} increased from 0.97 in the reference to 1.17 and 1.18 for Example 1 and Example 2, respectively, thereby indicating a lower graphitic disorder.

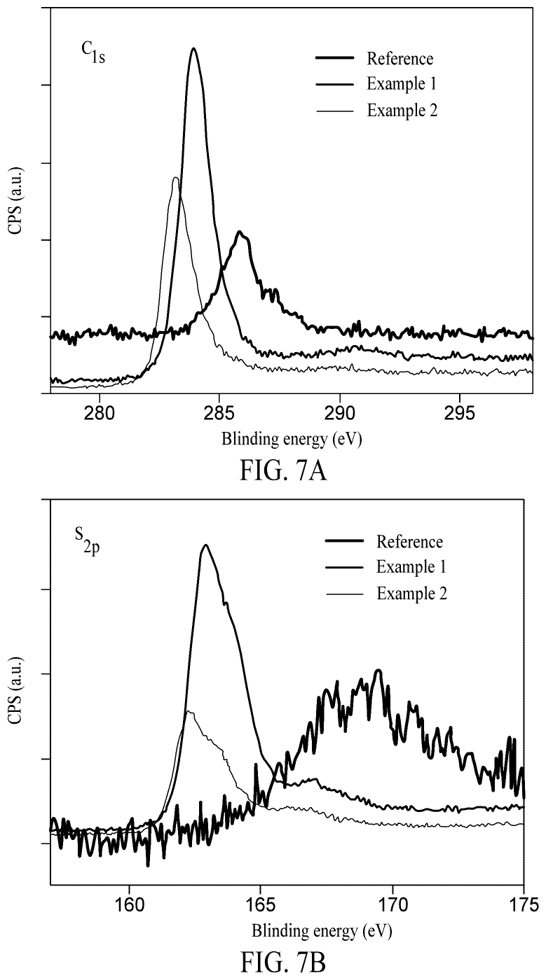

The C1s and S2p peaks for Example 1 and Example 2 shifted to a lower binding energy, indicating that the carbon bonding has changed, when compared to the reference XPS spectrum, as shown in FIGS. 7A and 7B.

### Electrocatalyst Synthesis

A physical loading method was used to load catalysts onto the thio-modified carbon supports. The physical loading method included physically mixing the hollow structured catalyst with each of a reference vulcanized carbon (Reference), Example 1, and Example 2, individually by sonication. About 6 mg of the metal catalyst was weighed in an empty vial. Iso-propanol alcohol (IPA), 0.4 ml, was added to the vial and the dispersion was sonicated for one minute. 6 mg of carbon was added to the dispersion and sonicated. 1.2 ml of DI water and 16 μL ionomer, e.g., sulfonated tetrafluoroethylene based fluoropolymer-copolymer, such as Nafion by Sigma-Aldrich, 5 wt %, density of 0.924 g/ml, was added to form the composition. The composition was sonicated in an ice bath for 2 hours.

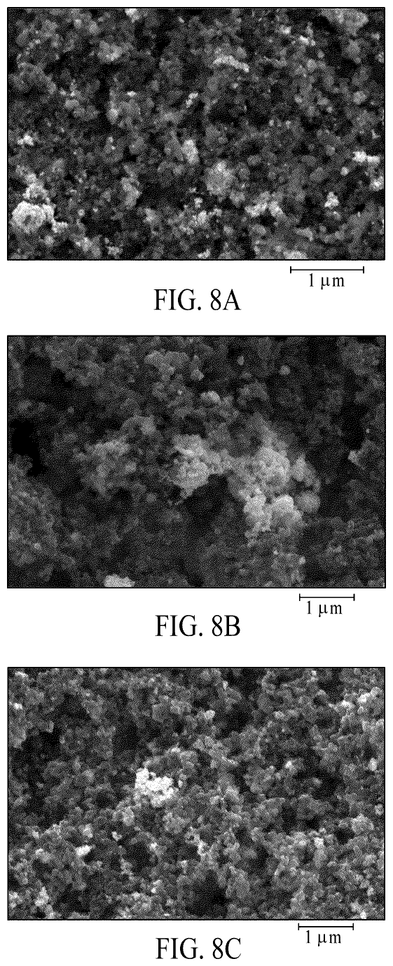

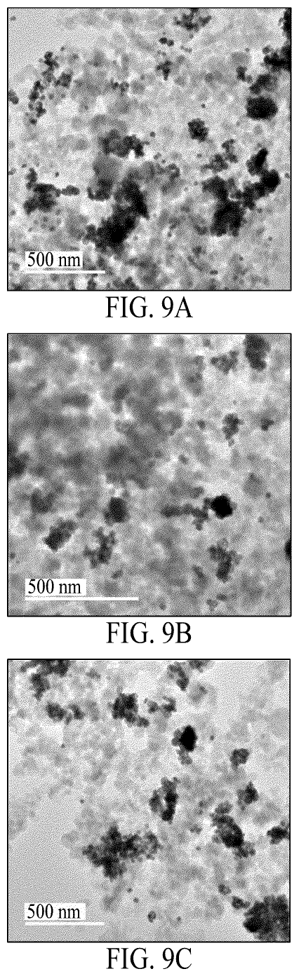

No morphology differences were shown between reference, example 1, and example 2, indicating formation of the electrocatalyst using the thio-modified carbon support, as shown in FIGS. 8A-8C. Additionally, transmission electron microscope images showed similar binding of the catalyst to the thio-modified carbon support, indicating slight aggregation patterns, as shown in FIGS. 9A-9C. However, uniform distribution of carbon (C), fluorine (F), sulfur(S), and nitrogen (N) was found using SEM elemental mapping of reference, example 1, and example 2, as shown in FIG. 10. Examples 1 and 2 had higher concentrations of catalyst in the electrocatalyst compared to the reference sample, indicating an enhanced interaction between the thio-modified carbon support and the catalyst nanoparticle, as shown below in Table 2.

TABLE 2

| Sample/ | C | F | Pt | Ni |
|---|---|---|---|---|
| Element | (weight %) | (weight %) | (weight %) | (weight %) |
| Reference | 69 | 3 | 15 | 12 |
| Example 1 | 60 | 2 | 26 | 12 |
| Example 2 | 63 | 2 | 23 | 11 |

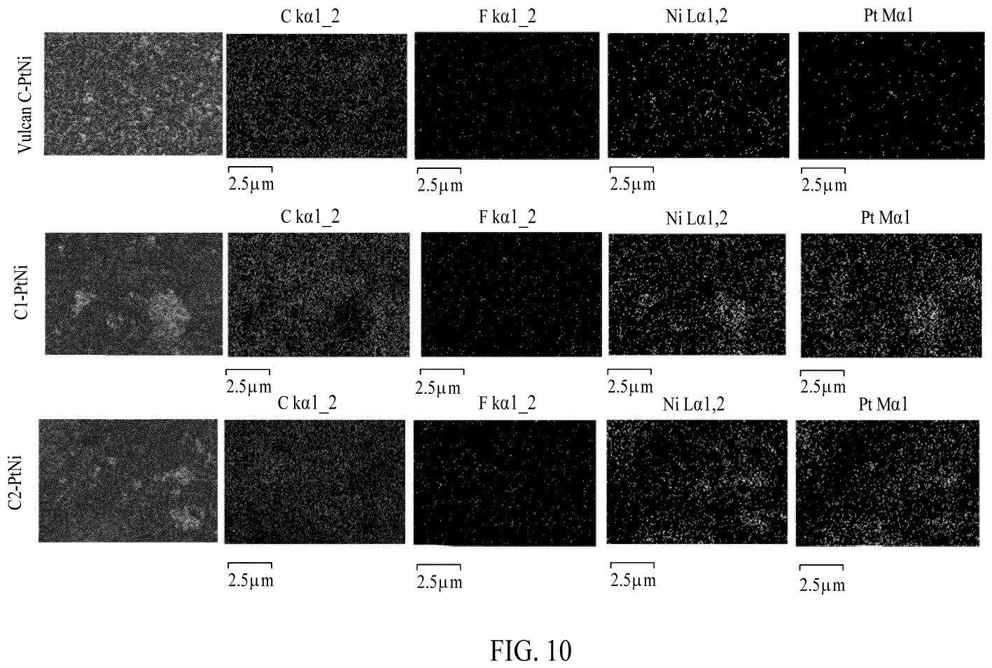

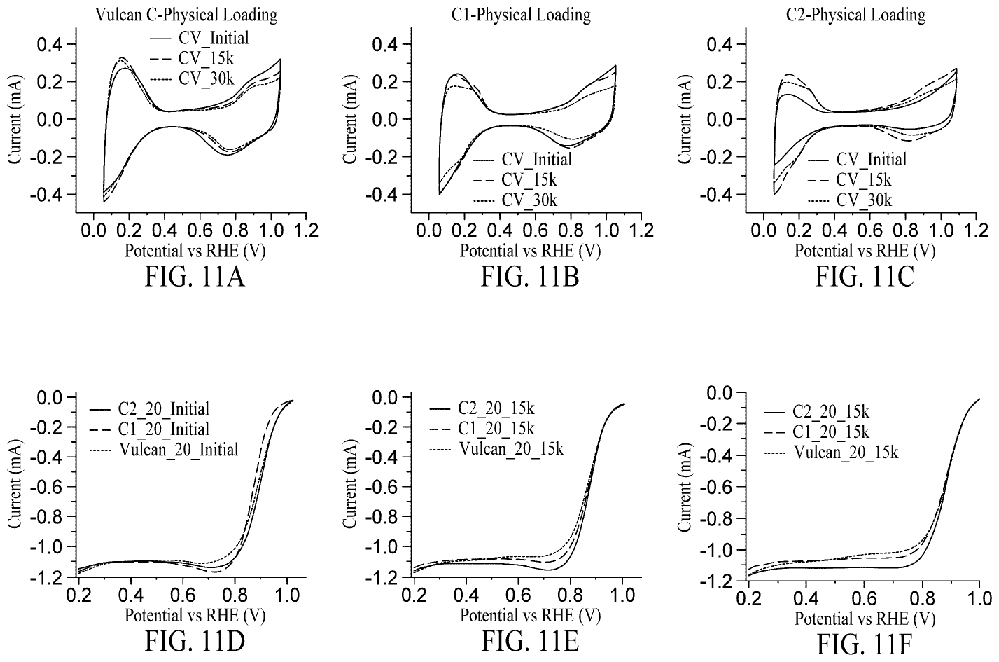

An electrochemical performance was measured using a RDE for each of the reference, example 1, and example 2 after performing 30,000 cycles. Platinum concentration was determined based on inductively coupled-mass spectrometry (ICP-MS), and electrochemical surface area (ECSA) was calculated from the hydrogen desorption data measured from the cyclic voltammetry, as shown in FIGS. 11A-11C. Linear sweep voltammetry was performed under saturated O₂ gas, as shown in FIGS. 11D-11F. The current at 0.9 V and 0.4 V were to evaluate the kinetics of the ORR. The initial kinetic current of examples 1 and 2 were 0.05 A/mg platinum. In the initial measurement, the current density at 0.4 V vs. RHE are overlay with each other. After 30,000 cycling, the reference degraded faster than example 2.

### ASPECTS LISTING

The present disclosure provides, among others, the following aspects, each of which can be considered as optionally including any alternate aspects:

Clause 1. An electrocatalyst including a thio-modified carbon support including a carbon support, the carbon support including a carbon black; a ligand coupled to the carbon support, in which the ligand includes a thiol group; and a metal catalyst coupled to the ligand.

Clause 2. The electrocatalyst of clause 1, in which the electrocatalyst includes an average particle size of about 20 nm to about 60 nm.

Clause 3. The electrocatalyst of clause 1 or 2, in which the ligand is selected from the group consisting of a thio-modified C₁-C₁₀ alkyl, thio-modified C₁-C₁₀ alkylene, thio-modified C₆-C₂₀ aryl, and thio-modified C₃-C₂₀ alicyclic ring.

Clause 4. The electrocatalyst of clause 3, in which the ligand is a thio-modified C₆-C₂₀ aryl.

Clause 5. The electrocatalyst of clause 4, in which the ligand is a thio-modified C₆ phenyl ring.

Clause 6. The electrocatalyst of any one of clauses 1-5, in which the metal catalyst is selected from the group consisting of a transition metal, a lanthanide metal, and an actinide metal. Clause 7. The electrocatalyst of clause 6, in which the metal catalyst is platinum.

Clause 8. The electrocatalyst of any one of clauses 1-7, in which the metal catalyst has a shape that is a hollow particle.

Clause 9. The electrocatalyst of any one of clauses 1-8, in which the electrocatalyst includes a weight ratio of the thio-modified carbon support to the metal catalyst of about 0.1:1 to about 10:1.

Clause 10. The electrocatalyst of clause 10, in which the electrocatalyst includes a weight ratio of the thio-modified carbon support to the metal catalyst of a about 0.1:1 to about 1:1.

Clause 11. A method of producing an electrocatalyst, the method including preparing a carbon slurry including a carbon support disposed in a diluent, the carbon support including a carbon black; introducing a ligand precursor including at least a thiol group with the carbon slurry to form a thio-modified carbon support; and coupling a metal catalyst with the thio-modified carbon support to form the electrocatalyst.

Clause 12. The method of clause 11, in which the electrocatalyst includes an average particle size of about 20 nm to about 60 nm.

Clause 13. The method of clause 11 or 12, in which the electrocatalyst includes a weight ratio of the thio-modified carbon support to the metal catalyst of about 0.1:1 to about 10:1.

Clause 14. The method of clause 13, in which the electrocatalyst includes a weight ratio of the thio-modified carbon support to the metal catalyst of a about 0.1:1 to about 1:1.

Clause 15. The method of any one of clauses 11-14, in which preparing the carbon slurry includes sonicating the carbon slurry at a frequency of about 20 kHz to about 80 kHz at a power of about 55 Watt to about 300 Watt.

Clause 16. The method of any one of clauses 11-15, in which forming the thio-modified carbon support includes disposing the ligand precursor including an amino precursor in the carbon slurry.

Clause 17. The method of clause 16, in which the ligand precursor is aminothiophenol.

Clause 18. The method of any one of clauses 11-17, in which introducing the ligand precursor with the carbon slurry is performed at a weight ratio of the ligand precursor to the carbon support of about 0.1:1 to about 10:1.

Clause 19. The method of any one of clauses 11-18, in which forming the thio-modified carbon support includes stirring a mixture of the ligand precursor with the carbon slurry for a period of about 1 min to about 20 min.

Clause 20. The method of any one of clauses 11-19, in which coupling the metal catalyst with the thio-modified carbon support includes mixing the metal catalyst with the thio-modified carbon support at a weight ratio of about 0.1:1 to about 10:1.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, for example, the terms “comprising,” “consisting essentially of,” “consisting of” also include the product of the combinations of elements listed after the term.

The use of headings is for purposes of convenience only and does not limit the scope of the present disclosure.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used herein, the term “about” when referring to a measurable value such as an amount, a temporal duration, and the like, is meant to encompass variations.

As used herein, the indefinite article “a” or “an” shall mean “at least one” unless specified to the contrary or the context clearly indicates otherwise. For example, aspects comprising “a metal” include aspects comprising one, two, or more metals, unless specified to the contrary or the context clearly indicates only one metal is included.

While the foregoing is directed to aspects of the present disclosure, other and further aspects of the disclosure may be devised without departing from the basic scope thereof, and the scope thereof is determined by the claims that follow.

What is claimed is:

1. An electrocatalyst comprising:
a thio-modified carbon support comprising:
a carbon support, the carbon support comprising a carbon black;
a ligand coupled to the carbon support, wherein the ligand comprises a thiol group; and
a metal catalyst coupled to the ligand.

2. The electrocatalyst of claim 1, wherein the electrocatalyst comprises an average particle size of about 20 nm to about 60 nm.

3. The electrocatalyst of claim 1, wherein the ligand is selected from the group consisting of a thio-modified C₁-C₁₀ alkyl, thio-modified C₁-C₁₀ alkylene, thio-modified C₆-C₂₀ aryl, and thio-modified C₃-C₂₀ alicyclic ring.

4. The electrocatalyst of claim 3, wherein the ligand is a thio-modified C₆-C₂₀ aryl.

5. The electrocatalyst of claim 4, wherein the ligand is a thio-modified C₆ phenyl ring.

6. The electrocatalyst of claim 1, wherein the metal catalyst is selected from the group consisting of a transition metal, a lanthanide metal, and an actinide metal.

7. The electrocatalyst of claim 6, wherein the metal catalyst is platinum.

8. The electrocatalyst of claim 1, wherein the metal catalyst has a shape that is a hollow particle.

9. The electrocatalyst of claim 1, wherein the electrocatalyst comprises a weight ratio of the thio-modified carbon support to the metal catalyst of about 0.1:1 to about 10:1.

10. The electrocatalyst of claim 9, wherein the electrocatalyst comprises a weight ratio of the thio-modified carbon support to the metal catalyst of a about 0.1:1 to about 1:1.

11. A method of producing an electrocatalyst, the method comprising:
preparing a carbon slurry comprising a carbon support disposed in a diluent, the carbon support comprising a carbon black;
introducing a ligand precursor comprising at least a thiol group with the carbon slurry to form a thio-modified carbon support; and
coupling a metal catalyst with the thio-modified carbon support to form the electrocatalyst.

12. The method of claim 11, wherein the electrocatalyst comprises an average particle size of about 20 nm to about 60 nm.

13. The method of claim 11, wherein the electrocatalyst comprises a weight ratio of the thio-modified carbon support to the metal catalyst of about 0.1:1 to about 10:1.

14. The method of claim 13, wherein the electrocatalyst comprises a weight ratio of the thio-modified carbon support to the metal catalyst of a about 0.1:1 to about 1:1.

15. The method of claim 11, wherein preparing the carbon slurry comprises sonicating the carbon slurry at a frequency of about 20 kHz to about 80 kHz at a power of about 55 Watt to about 300 Watt.

16. The method of claim 11, wherein forming the thio-modified carbon support comprises disposing the ligand precursor comprising an amino precursor in the carbon slurry.

17. The method of claim 16, wherein the ligand precursor is aminothiophenol.

18. The method of claim 11, wherein introducing the ligand precursor with the carbon slurry is performed at a weight ratio of the ligand precursor to the carbon support of about 0.1:1 to about 10:1.

19. The method of claim 11, wherein forming the thio-modified carbon support comprises stirring a mixture of the ligand precursor with the carbon slurry for a period of about 1 min to about 20 min.

20. The method of claim 11, wherein coupling the metal catalyst with the thio-modified carbon support comprises mixing the metal catalyst with the thio-modified carbon support at a weight ratio of about 0.1:1 to about 10:1.
